(19) United States
(12) Patent Application Publication
(10) Pub. No.: US 2014/0182881 A1
(43) Pub. Date: Jul. 3, 2014

(54) SHIELDED CABLE

(71) Applicant: HITACHI CABLE, LTD, Tokyo (JP)

(72) Inventors: Detian HUANG, Hitachi (JP); Masanori Kobayashi, Hitachi (JP)

(73) Assignee: Hitachi Cable, Ltd, Tokyo (JP)

(21) Appl. No.: 13/889,192

(22) Filed: May 7, 2013

(30) Foreign Application Priority Data
Dec. 28, 2012 (JP) 2012-287152

(51) Int. Cl. H01B 7/30

(52) U.S. Cl. CPC H01B 7/303
USPC 174/103

(57) ABSTRACT

A shielded cable includes a twisted cable including a plurality of electric wires each including a conductor covered with an insulation therearound, and an electrically conductive wire twisted together with the plurality of electric wires, and a strip-like member including a conductive layer and an insulating layer. The strip-like member is wound around the twisted cable in the same direction as a twist direction of the twisted cable and at substantially the same winding pitch as a twist pitch of the twisted cable such that the conductive layer is continuously contacted with and along the lead wire.

The present application is based on Japanese patent application No. 2012-287152 filed on Dec. 28, 2012, the entire contents of which are incorporated herein by reference.

### BACKGROUND OF THE INVENTION

1. Field of the Invention

This invention relates to a shielded cable.

2. Description of the Related Art

In conventional art, a shielded cable for a differential transmission, which comprises two signal wires arranged in parallel, a drain wire disposed along the signal wires, and a metal foil resin tape including a resin tape and a metal foil formed over a surface of the resin tape, wherein the metal foil resin tape is helically wound around the signal wires and the drain wire, has been known (see, for example, JP-A-2011-222262).

In this shielded cable, the metal foil resin tape is folded at one end in a width direction thereof such that the metal foil is located outside, and is wound in such a manner that the metal foil overlaps itself at the folded portion of the metal foil resin tape and thereby electrically contact the overlapped metal foil portions together. Consequently, in the conventional shielded cable, electric current flowing in the metal foil resin tape flows along the drain wire without interruption. It is therefore possible to suppress the occurrence of a sharp signal drop, so called “suck-out” phenomenon, in a high frequency band.

Refer to JP-A-2011-222262, for example.

### SUMMARY OF THE INVENTION

However, with the conventional shielded cable, the metal foil tends to crack in comparison with a shielded cable with an unfolded metal foil resin tape. For this reason, with the conventional shielded cable, the electric current flowing in the metal foil resin tape is interrupted by electrical conduction failure in the cracked portion, and the performance of suppressing the suck-out phenomenon is likely to lower. Also, the conventional shielded cable is hard to be bent and hard to be handled due to the parallel arrangement of the two signal wires.

Accordingly, it is an object of the present invention to provide a shielded cable, which suppresses a suck-out phenomenon, and which is easy to be handled.

According to an embodiment of the invention, a shielded cable comprises:

a twisted cable including a plurality of electric wires each comprising a conductor covered with an insulation therearound, and an electrically conductive wire twisted together with the plurality of electric wires; and

a strip-like member including a conductive layer and an insulating layer, the strip-like member being wound around the twisted cable in the same direction as a twist direction of the twisted cable and at substantially the same winding pitch as a twist pitch of the twisted cable such that the conductive layer is continuously contacted with and along the lead wire.

In the embodiment, the following modifications and changes can be made.

In the strip-like member, the conductive layer is not less than 6 μm and not more than 9 μm in thickness, while the insulating layer is not less than 4 μm and not more than 6 μm in thickness.

(Points of the Invention)

According to the invention, it is possible to suppress a suck-out phenomenon, and is easy to handle the shielded cable.

### BRIEF DESCRIPTION OF THE DRAWINGS

The preferred embodiments according to the invention will be explained below referring to the drawings, wherein:

FIG. 1A is a perspective view showing a shielded cable in an embodiment according to the invention;

FIG. 1B is a cross sectional view taken along line IB-IB in FIG. 1A in which the cross section is viewed from an arrow direction;

FIG. 2A is a schematic explanatory diagram showing a diameter of a drain wire of the shielded cable in the present embodiment;

FIG. 2B is a cross sectional view taken along line IIB-IIB in FIG. 1A in which the cross section is viewed from an arrow direction;

FIG. 2C is a cross sectional view showing a metal resin tape; and

FIG. 3 is a graph showing relationship between transmission loss (dB) and frequency (GHz) in Example 1 according to the invention.

### DETAILED DESCRIPTION OF THE PREFERRED EMBODIMENT

Next, a preferred embodiment according to the invention will be described below in conjunction with the accompanying drawings. Incidentally, in these figures, elements having substantially the same functions are given the same reference numerals, and duplicated descriptions thereof are omitted.

(Summary of the Embodiment)

A shielded cable in the embodiment comprises a twisted cable including a plurality of electric wires each comprising a conductor covered with an insulation therearound, and a lead wire having an electrical conductivity and being twisted together with the plurality of electric wires. The shielded cable further comprises a strip-like member including a conductive layer and an insulating layer. The strip-like member is wound around the twisted. cable in the same direction as a twist direction of the twisted cable and at substantially the same winding pitch as a twist pitch of the twisted cable, so that the conductive layer is continuously contacted with and along the lead wire.

Here, the term “substantially the same winding pitch” is used to allow for a margin of error (e.g., 10 percent error of the twist pitch) in. twisting the twisted cable and winding the strip-like member.

According to the above described configuration, since the strip-like member is wound around the twisted cable in the same direction as the twist direction of the twisted cable and at substantially the same winding pitch as the twist pitch of the twisted cable, the conductive layer is continuously contacted with and along the lead wire. It is therefore possible to suppress a suck-out phenomenon. Also, since the strip-like member is helically wound around the twisted cable including the plurality of electric wires and the lead wire twisted together, the shielded cable can be bent easily and can be handled easily, in comparison with a cable with a plurality of electric wires and a lead wire arranged in parallel.

### Embodiment

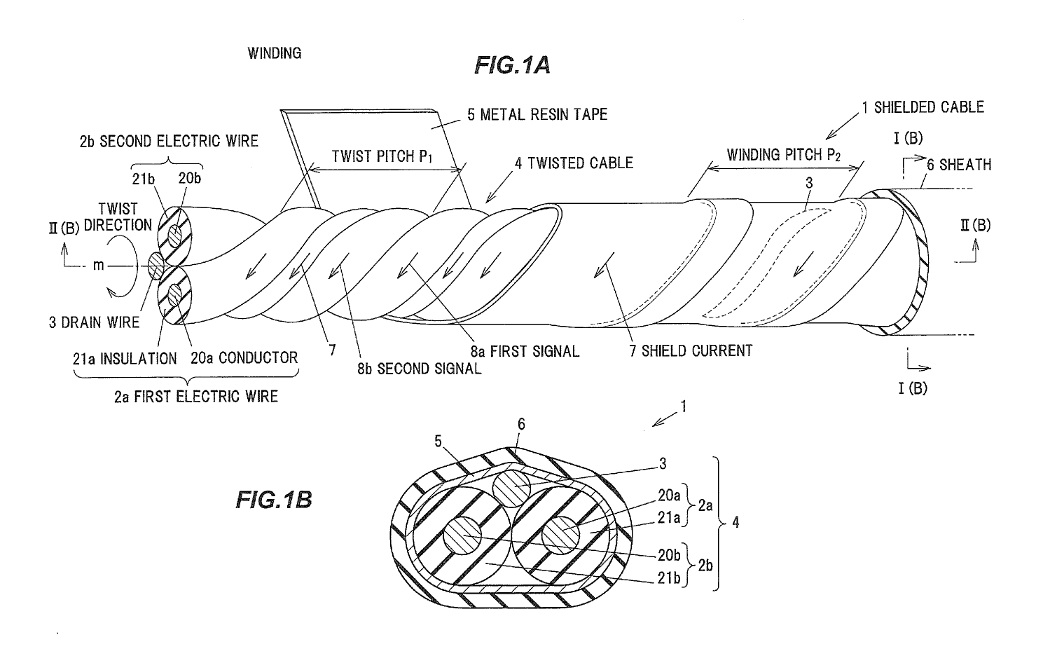

FIG. 1A is a perspective view showing a shielded cable in an embodiment according to the invention, and FIG. 1B is a cross sectional view taken along line IB-IB in FIG. 1A in which the cross section is viewed from an arrow direction. Incidentally, in each figure in the embodiment, the drawing scale ratio may be different from the real ratio.

The shielded cable 1 is used primarily as a cable for high speed transmission in accordance with LVDS (Low Voltage Differential Signaling) standards or next generation standards after LVDS standards, such as 10 Gbps or higher speed digital signal transmission, as one example. This shielded cable 1 may also be used as a cable for low speed digital signal transmission, for example.

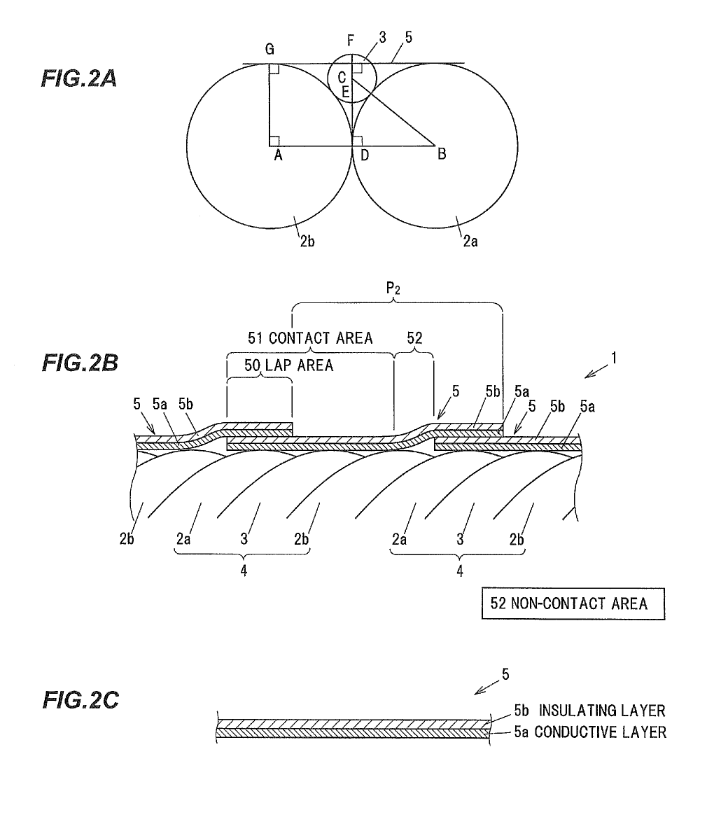

As shown in FIG. 1A, this shielded cable 1 is schematically configured as comprising a twisted cable 4 including first and second electric wires 2a and 2b as a plurality of electric wires each comprising a conductor covered with an insulation therearound, and a drain wire 3 as a lead wire having the electrical conductivity arid being twisted together with the first and second electric wires 2a and 2b; and as shown in FIGS. 2B and 2C described later, a metal resin tape 5 as a strip-like member including a conductive layer 5a and an insulating layer 5b, wherein the metal resin tape 5 is wound around the twisted cable 4 in the same direction as a twist direction of the twisted cable 4 and at substantially the same winding pitch as a twist pitch of the twisted cable 4, so that the conductive layer 5a is continuously contacted with and along the drain wire 3.

Incidentally, although in this embodiment the plurality of electric wires are configured as the first and second electric wires 2a and 2b for differential signal transmission, they are not limited thereto, but a further plurality of electric wires may be provided. For example, quad cables using two pairs of the first and second electric wires 2a and 2b for differential signal transmission may be twisted together to produce the twisted cable 4, or a further plurality of pairs of the first and second electric wires 2a and 2b for differential signal transmission may be twisted together to produce the twisted cable 4.

Also, the shielded cable 1 is provided with a sheath 6 for covering the metal resin tape 5 wound around the twisted cable 4.

(Configuration of the First and Second Electric Wires 2a and 2b)

As shown in FIGS. 1A and 1B, the first electric wire 2a comprises a conductor 20a having the electrical conductivity, and an insulation 21a having the electrical insulative property and covering the conductor 20a. Also, the second electric wire 2b comprises a conductor 20b formed in the same shape as the conductor 20a using the same material as the conductor 20a, and an insulation 21b formed in the same shape as the insulation 21a using the same material as the insulation 21a.

As shown in FIG. 1A, a first signal 8a as high speed digital signal (differential signal) is transmitted in the first electric wife 2a. A second signal 8b which is phase-shifted by 180 degrees from the first signal 8a is transmitted in the second electric wire 2b.

The conductors 20a and 20b are a solid wire or stranded wire formed using e.g. a metal such as aluminum, copper or an alloy primarily including Al, Cu, etc. Also, the conductors 20a and 20b may be plated, for example. As one example, the conductors 20a and 20b in this embodiment are a stranded wire in which a plurality of wires formed using annealed copper plated with tin, so called Sn-plated annealed copper, are twisted together.

Here, the electrical conductivity is used in the meaning of being electrically conductive in ranges of electric current and voltage in which the shielded cable 1 is properly used. Similarly, the electrical insulative property is used in the meaning of being electrically insulating in ranges of electric current and voltage in which the shielded cable 1 is properly used.

The insulations 21a and 21b are formed by covering an insulating material with small dielectric constant and dielectric loss tangent around the conductors 20a and 20b. Specifically, as the material of the insulations 21a and 21b, a resin material such as polyvinyl chloride, polyethylene, polypropylene, polytetrafluoroethylene (PTFE), tetrafiuoroethylene-hexafluoropropylene copolymer, (FEP), tetrafluoroethylene-perfluoroalkyl vinyl ether copolymer (PFA), etc.

Further, as the insulations 21a and 21b, a foam insulation resin may be used in order to reduce the dielectric constant and the dielectric loss tangent. As a method of forming the foam insulation resin, a known method such as a method comprising the steps of kneading a foaming agent into the resin material prior to molding and controlling the degree of foam with temperature during molding, a method comprising the steps of injecting a gas such as nitrogen and foaming when releasing pressure, etc. may be used. As one example, the insulations 21a and 21b in this embodiment are formed using polyethylene.

In the first and second electric wires 2a and 2b, the cross sectional areas of the conductors 20a and 20b and the thicknesses of the insulations 21a and 21b may appropriately be altered according to, e.g., communications standards for which the shielded cable 1 is used.

Incidentally, it is preferred that the cross sectional areas of the conductors 20a and 20b of the first and second electric wires 2a and 2b are the same and are less variable, and that the thicknesses of the insulations 21a and 21b of the first and second electric wires 2a and 2b are the same and are less variable. That is, by the cross sectional areas of the conductors 20a and 20b being the same and less variable, and by the thicknesses of the insulations 21a and 21b being the same and less variable, the distance between the conductors 20a and 20b is the same at an arbitrary section, and the physical lengths of the first and second electric wires 2a and 2b are the same so that the electric wires are held symmetric. It is therefore possible to suppress the occurrence of a skew, etc. due to electrostatic coupling between the conductors 20a and 20b, etc.

Here, the cross sectional areas of the conductors described above refer to a cross sectional area perpendicular to the central axis of the conductors in the case of a solid wire, or an area of a circle in which the wire aggregate is inscribed at the cross section perpendicular to the central axis of the conductors in the case of a stranded wire. Also, the thicknesses of the insulations refer to a circumferential thickness around the central axis of the electric wires. Here, the central axis is an axis through the center of a wire transverse cross section, and the wires are rotationally symmetric around the central axis. Herein, unless it is explicitly stated otherwise, the cross sectional areas, the thicknesses and the central axis refer to the cross sectional area, the thickness and the central axis described above.

(Configuration of the Drain Wire 3)

FIG. 2A is a schematic explanatory diagram showing a diameter of a drain wire of the shielded cable in the present embodiment, and FIG. 2B is a cross sectional view taken along line IIB-IIB in FIG. 1A in which the cross section is viewed from an arrow direction, and FIG. 2C is a cross sectional view showing a metal resin tape. In FIG. 2B, for description, the cross section of the metal resin tape 5 is shown, and the sheath 6 is omitted. FIG. 2C schematically shows the cross section at which the metal resin tape 5 is cut in the width direction.

The drain wire 3 is a solid wire or stranded wire formed using e.g. a metal such as aluminum, copper or an alloy primarily containing Al, Cu, etc. Also, the drain wire 3 may be plated, as one example. Also, the number of the drain wire 3 may appropriately be altered according to applications. The drain wire 3 in this embodiment is e.g. a stranded wire in which a plurality of wires formed using Sn-plated annealed copper are twisted together. In FIGS. 1A and 1B, the cross sections of the conductors 20a and 20b and the drain wire 3 which are the stranded wire are shown as one circle of the wire aggregate.

The drain wire 3 is electrically connected to, e.g., a ground (GND) prepared when the shielded cable 1 is connected to electronic devices, etc. By connecting the drain wire 3 to the GND, it is possible to prevent a conductor such as a metal, etc. placed near the shielded cable 1 from affecting the shielded cable 1, and to stabilize characteristic impedance of the shielded cable 1. The drain wire 3 is contacted with the conductive layer 5a of the metal resin tape 5, thereby electrically connecting the conductive layer 5a to the GND. That is, in the shielded cable 1, shield current 7 flowing through the metal resin tape 5 flows to the GND via the drain wire 3, thereby allowing shielding performance to be held stable. In view of this, it is preferred that the drain wire 3 is continuously contacted with the conductive layer 5a, and is disposed so that the twisted cable 4 is held symmetric. Therefore, the drain wire 3 is twisted together with the first and second electric wires 2a and 2b so that the twisted cable 4 is held symmetric.

Also, in order to facilitate the contacting of the drain wire 3 with the conductive layer 5a, the drain wire 3 has preferably a diameter of not smaller than a quarter of a diameter of the electric wires. Incidentally, the diameters of the electric wires are a diameter when the cross section of the electric wires perpendicular to the central axis is circular. The diameter of the drain wire 3 is a diameter when the cross section of the drain wire 3 perpendicular to the central axis is circular.

Specifically, the diameter of the drain wire 3 is calculated as follows. First, as shown in FIG. 2A, when the diameters of the first and second electric wires 2a and 2b are the same, for a right-angled triangle BCD, the following formula (1) is established according to the Pythagorean theorem.

BD²+CD²=BC² (1),

where Points A to G are defined as follows:
Point A: the center of the first electric wire 2a
Point B: the center of the second electric wire 2b
Point C: the center of the drain wire 3
Point D: the contact point of the first and second electric wires 2a and 2b
Point E: the intersection near segment AB of the line through the Points C and D and the circle indicative of the cross section of the drain wire 3
Point F: the intersection distant from the segment AB of the line through the Points C and D and the circle indicative of the cross section of the drain wire 3
Point G: the contact point of the first electric wire 2a and the surface of the conductive layer 5a of the metal resin tape 5

As shown in FIG. 2A, the diameter (segment EF) of the drain wire 3 can be determined from the condition: the length of segment DF is not smaller than the length of segment AG Therefore, the following formula (2) is established.

AG≧DF=DE+CE+CF (2)

Using formulas (1) and (2), for the segment CE, the following formula (3) is established.

AG/4≧CE (3)

AG is the radius of the first electric wire 2a, and CE is the radius of the drain wire 3. Therefore, the diameter of the drain wire 3a is not smaller than a quarter of the diameter of the first and second electric wires 2a and 2b.

Incidentally, the diameter of the drain wire 3a is preferably smaller than the diameter of the first and second electric wires 2a and 2b. It is because if the diameter of the drain wire 3a is greater than the diameter of the first and second electric wires 2a and 2b, the shielded cable increases in weight and cost, and is hard to be bent, i.e., hard to be handled. Therefore, the diameter of the drain wire 3a is more preferably not smaller than a quarter of the diameter of the first and second electric wires 2a and 2b, and not greater than the diameter of the first and second electric wires 2a and 2b.

(Configuration of the Twisted Cable 4)

The twisted cable 4 is such configured that the first and second electric wires 2a and 2b and the drain wire 3 are twisted together. In the twisted cable 4, the first and second electric wires 2a and 2b and the drain wire 3 are twisted together in such a manner as to be held at a distance therebetween at the cross section perpendicular to the central line of the twisted cable 4.

The twist direction T of the twisted cable 4 is the clockwise direction as indicated by an arrow in FIG. 1A, when the twisted cable 4 is viewed from the left side in FIG. 1A, as one example. In other words, the first and second electric wires 2a and 2b and the drain wire 3 are twisted together in the arrow direction around the central axis m of the shielded cable 1 when viewed from the left side in FIG. 1A. Incidentally, the twist direction T may be the counterclockwise direction.

The twist pitch P₁ of the twisted cable 4 is a distance in the longitudinal direction of the shielded cable 1 of exposed regions of the first electric wire 2a, the second electric wire 2b and the drain wire 3 at a surface of the twisted cable 4. In other words, the twist pitch P₁ is a distance that the twisted cable 4 advances along the direction of the central axis m in one circumferential twist around the central axis m of the shielded cable 1.

Here, if the drain wire is longitudinally placed along the twisted pair cable with the two electric wires twisted together, the cable is not symmetric, i.e., the distance between one electric wire and the drain wire, and the distance between the other electric wire and the drain wire vary with location of the cable,. and therefore, due to the electrostatic coupling effect, etc. the characteristic impedance is not stable and a skew, etc. tends to occur.

However, since the twisted cable 4 in this embodiment is formed by twisting the first and second electric wires 2a and 2b and the drain wire 3 together, the distance between the first electric wire 2a and the second electric wire 2b, the distance between the first electric wire 2a and the drain wire 3, and the distance between the second electric wire 2b and the drain wire 3 are constant at any location. Therefore, the twisted cable 4 is symmetric.

(Configuration of the Metal Resin Tape 5)

As shown in FIGS. 2B and 2C, the metal resin tape 5 is schematically configured as comprising a conductive layer 5a having the electrical conductivity and an insulating layer 5b having the electrical insulative property. This metal resin tape 5 has a long and thin strip-like shape. This metal resin tape 5 is wound in such a manner that the conductive layer 5a is on the side of the twisted cable 4, and gaps between the metal resin tape 5 and the twisted cable 4 lessen.

The conductive layer 5a is e.g. a metal layer formed over one surface of the insulating layer 5b by metallization, etc. This conductive layer 5a is formed using a metal such as aluminum, nickel, copper or an alloy primarily containing Al, Ni, Cu, etc. as one example. Also, the conductive layer 5a may be plated, as one example. Incidentally, the conductive layer 5a may be e.g. a single layer using the above described metal material, or a layer in which a plurality of the metal materials are stacked together. Also, the metal resin tape 5 may be formed by bonding a metal foil formed using the above described metal material to the insulating layer 5b, but is not limited thereto.

The insulating layer 5b is formed using a resin material, such as polyethylene, polyethylene terephthalate (PET), etc. as a film base material, as one example.

For the metal resin tape 5, the conductive layer 5a is preferably not less than 6 μm and not more than 9 μm in thickness, while the insulating layer 5b is preferably not less than 4 μm and not more than 6 μm in thickness. This is because if the conductive layer 5a is thinner in thickness than 6 μm, the conductive layer 5a is likely to be cracked or broken by bending, etc. of the shielded cable 1, and its shielding performance is likely to lower. It is also because if the conductive layer 5a is thicker in thickness than 9 the shielded cable 1 lowers in softness and flexibility, and increases in weight and is hard to be handled. Further, it is also because if the insulating layer 5b is thinner in thickness than 4 μm, as with the conductive layer 5a, the insulating layer 5b is likely to be cracked or broken. It is also because if the insulating layer 5b is thicker in thickness than 6 μm, the shielded cable 1 is likely to lower in softness and flexibility.

The metal resin tape 5 has a width of the twist pitch P₁ plus overlapped portions, and is helically wound in such a manner as to partially overlap itself in its width direction, i.e., in its transverse direction perpendicular to its longitudinal direction. Specifically, as shown in

FIG. 1A, the metal resin tape 5 is wound around the twisted cable 4 in the same direction as the twist direction of the twisted cable 4 and at substantially the same winding pitch P₂ as the twist pitch P₁ of the twisted cable 4.

Although this winding pitch P₂ is preferably the same as the twist pitch P₁, it may be substantially the same, i.e., have a deviation (e.g., 10 percent error) in a range in which the drain wire 3 and the conductive layer 5a of the metal resin tape 5 are continuously and electrically contacted together in the longitudinal direction of the drain wire 3. This allows the drain wire 3 to be longitudinally placed along the metal resin tape 5. Therefore, as shown in FIG. 1A, the shield current 7 flowing through the conductive layer 5a does not flow in the direction of the central axis in of the shielded cable 1, but helically flows.

Also, the metal resin tape 5 is wound around the twisted cable 4 in such a manner that its ends in its width direction are overlapped together. This overlapped portion is a lap area 50 as indicated in FIG. 2B. Incidentally, the winding is performed in such a manner that the width of the lap area 50 is substantially the same, but is not limited thereto.

As one example, the metal resin tape 5 is wound to overlap itself by ½ to ¼ of its width. Incidentally, although the metal resin tape 5 needs not necessarily be wound to overlap itself, it is preferably wound to overlap itself so as not to expose the twisted cable 4 from gaps in the Metal resin tape 5 due to bending, etc. and lower its shielding performance.

The winding pitch P₂ is also a length of this lap area 50, for example. In other words, the winding pitch P₂ is a distance forward in the central axis m direction the metal resin tape 5 moves in one circumferential wrap around the central axis m of the shielded cable 1.

As shown in FIG. 2B, in the lap area 50, the overlaps occur from the side of the twisted cable 4 in the order of the conductive layer 5a, the insulating layer 5b, the conductive layer 5a, and the insulating layer 5b. That is, in the lap area 50, the overlapped conductive layers 5a are not electrically connected together, and therefore as shown in FIG. 1A, the shield current 7 flowing through the metal resin tape 5 does not flow in the direction of the central axis m of the shielded cable 1, but helically flows along the metal resin tape 5.

On the other hand, a contact area 51 shown in FIG. 2B represents the conductive layer 5a to be contacted with the twisted cable 4. Also, a non-contact area 52 shown in FIG. 2B represents a gap area in the overlap of the metal resin tape 5. The contact area 51 is an area extending from an end of the conductive layer 5a on the side of the twisted cable 4 to a position just before the conductive layer 5a moves onto the metal resin tape 5, i.e., an area in which the conductive layer 5a may be contacted with the twisted cable 4. The metal resin tape 5 is wound at the winding pitch P₂ for the drain wire 3 to be located at least within the contact area 51.

That is, as shown in FIG. 2B, the metal resin tape 5 is wound around the twisted cable 4 in such a manner that the adjacent first and second electric wires 2a and 2b and the drain wire 3 are located within the contact area 51. In other words, the metal resin tape 5 is wound as if the first and second electric wires 2a and 2b and the drain wire 3 are longitudinally wrapped by the metal resin tape 5. Therefore, the drain wire 3 is continuously contacted along the metal resin tape 5 and with the contact area 51.

Here, it is known that due to a resonance phenomenon dependent on the winding pitch of the metal resin tape, a sharp signal attenuation, so called suck-out phenomenon occurs in some frequency bands. This suck-out is a phenomenon which significantly appears in high speed digital signal transmission. The suck-out phenomenon is caused primarily by the occurrence of a resonance phenomenon dependent on a period arising front the existence of a portion in which the shield current flowing from the conductive layer of the metal resin tape to the drain wire and the GND is not conducted with constant synchrony along the drain wire on the metal resin tape (the overlapped portions of the metal resin tape). Also, when the drain wire is located in the above described non-contact area, i.e., when the drain wire and the conductive layer are intermittently contacted together, a resonance phenomenon occurs, thereby causing the suck-out phenomenon.

However, according to the shielded cable 1 in this embodiment, since the twisting direction of the twisted cable 4 and the winding direction of the metal resin tape 5 are the same, and the twist pitch P₁ of the twisted cable 4 and the winding pitch P₂ of the metal resin tape 5 are substantially the same, the drain wire 3 and the conductive layer 5a are continuously contacted together, thereby allowing the suppression of the suck-out phenomenon.

(Configuration of the Sheath 6)

The sheath 6 is formed by use of a thermoplastic resin material such as polyethylene, polyvinyl chloride, fluorine resin, etc. The sheath 6 is formed by, e.g., extrusion molding of the thermoplastic resin material, so as to cover the metal resin tape 5 wound around the twisted cable 4.

(Advantages of the Embodiment)

The shielded cable 1 in this embodiment allows the suppression of the suck-out phenomenon, and can be handled easily. Specifically, with the shielded cable 1, since the metal resin tape 5 is wound around the twisted cable 4 in the same direction as the twist direction of the twisted cable 4 and at substantially the same winding pitch P₂ as the twist pitch P₁ of the twisted cable 4, the conductive layer 5a is continuously contacted along and with the drain wire 3, thereby allowing the suppression of the suck-out phenomenon.

With the shielded cable 1, since the metal resin tape 5 is helically wound around the twisted cable 4 with the first and second electric wires 2a and 2b and the drain wire 3 twisted together, the shielded cable 1 can be easily bent and easily handled, in comparison with a Twinax cable in which a plurality of electric wires and a drain wire are arranged in parallel. Also, in the shielded cable 1, even when bent, since the drain wire 3 and the conductive layer 5a are stably contacted together, the shielded cable 1 allows stable shielding performance, and suppression of the suck-out phenomenon.

### Example 1

A specific example 1 is further described below. Incidentally, in Example 1, one specific example of the shielded cable 1 in the above described embodiment is given, but the invention is not limited thereto.

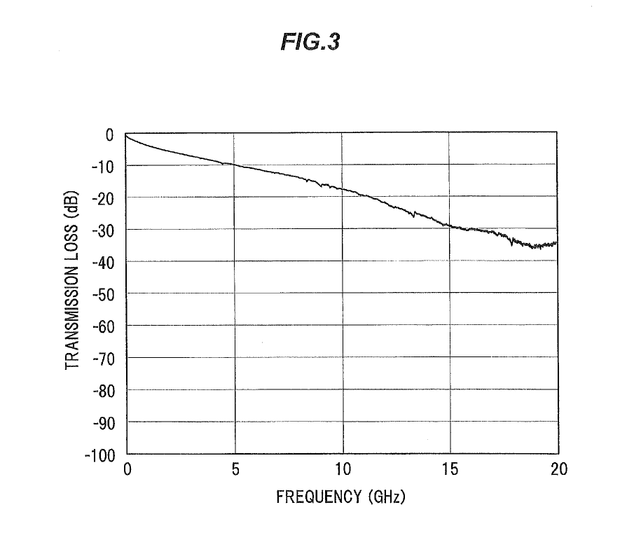

FIG. 3 is a graph showing a relationship between transmission loss (dB) and frequency (GHz) in Example 1 according to the invention. In FIG. 3, the vertical axis is transmission loss (dB), and the horizontal axis is frequency (GHz).

The shielded cable 1 in Example 1 is a 28 AWG (American Wire Gauge) LVDS cable. Specifically, the conductors 20a and 20b of the first and second electric wires 2a and 2b are a stranded wire in which seven 0.127 mm diameter wires are twisted together. The drain wire 3 is a stranded wire in which seven 0.127 mm diameter wires are twisted together. The conductive layer 5a of the metal resin tape 5 is made of aluminum, while the insulating layer 5b is PEI The conductive layer 5a is 9 μm thick, while the insulating layer 5b is 4 μm thick. Also, the outer diameter of the sheath 6 is 12.7 mm.

For this shielded cable 1, suck-out phenomenon measurements are performed with a network analyzer. More specifically, the cable length is 3 m, and the measurement frequency is 300 kHz to 20 GHz, and the network analyzer uses a network analyzer: type N5245A made by Agilent Technologies.

With the shielded cable 1 in Example 1, as shown in FIG. 3, no suck-out phenomenon was measured, even in a high frequency band, especially beyond 10 GHz.

Therefore, the shielded cable 1 in Example 1 can stably be used with no sharp transmission loss increase, i.e., sharp high frequency band signal drop, in the high speed digital signal transmission beyond 10 GHz. Consequently, the high speed digital signal transmission is possible between electronic devices or in electronic devices, allowing enhancement of performance of these electronic devices.

Incidentally, the invention is not limited to the above described embodiment and example, but various modifications may be made without altering the spirit and scope of the invention. Also, the elements of the above described embodiment may partially be omitted without altering the spirit and scope of the invention.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A shielded cable, comprising:
a twisted cable including a plurality of electric wires each comprising a conductor covered with an insulation therearound, and an electrically conductive wire twisted together with the plurality of electric wires; and
a strip-like member including a conductive layer and an insulating layer, the strip-like member being wound around the twisted cable in the same direction as a twist direction of the twisted cable and at substantially the same winding pitch as a twist pitch of the twisted cable such that the conductive layer is continuously contacted with and along the lead wire.

2. The shielded cable according to claim 1, wherein, in the strip-like member, the conductive layer is not less than 6 μm and not more than 9 μm in thickness, while the insulating layer is not less than 4 μm and not more than 6 μm in thickness.
